(19) United States
(12) Patent Application Publication
(10) Pub. No.: US 2010/0288163 A1
(43) Pub. Date: Nov. 18, 2010

(54) AQUEOUS INKJET INK COMPRISING A BLEED CONTROL AGENT

(75) Inventor: Jose Esteban Valentini, West Chester, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I Du Pont De Nemours and Company, WIlmington, DE (US)

(21) Appl. No.: 12/808,684

(22) PCT Filed: Oct. 1, 2008
(86) PCT No.: PCT/US08/78355

§ 371 Date: Jun. 17, 2010

Related U.S. Application Data
(60) Provisional application No. 61/008,005, filed on Dec. 18, 2007.

(51) Int. Cl. C09D 11/02

(52) U.S. Cl. 106/31.89; 106/31.13

(57) ABSTRACT

Disclosed is an aqueous inkjet ink comprising colorant and a bleed control agent comprised of 3-(2-methoxyphenoxy)-1-2-propanediol. The ink advantageously exhibits reduced intercolor bleed when printed, for example, on plain paper.

### CROSS-REFERENCE TO RELATED APPLICATION

This application claims priority from U.S. Provisional Application Ser. No. 61/008,005 (filed Dec. 18, 2007), the disclosure of which is incorporated by reference herein for all purposes as if fully set forth.

### BACKGROUND OF THE INVENTION

The present invention pertains to an aqueous inkjet ink and in particular to an aqueous inkjet ink comprising an aqueous vehicle, a colorant and a bleed control agent.

Inkjet printing is a non-impact printing process in which droplets of ink are deposited on a substrate, such as paper, to form the desired image. The droplets are ejected from a printhead in response to electrical signals generated by a microprocessor. Inkjet printers offer low cost, high quality printing and have become a popular alternative to other types of printers.

Inkjet printers are equipped with an ink set which, for full color printing, typically comprises a cyan, magenta and yellow ink (CMY). An ink set will also commonly comprise a black ink (CMYK).

Bleed of one color into another is a particular problem in ink jet printing because the inks are of relatively low viscosity and tend to spread, and because ink jet printers have the capability of printing three or four primary colors in simultaneous (or near simultaneous) fashion. Such color bleed often results in production of indistinct images with a poor degree of resolution.

Various methods have been proposed to prevent bleed of adjacent printing liquids. One method is to apply the two printing liquids at a distance from one another such that no intermingling or mixing of the printing liquids can occur. This method is not a solution to the problem, however, and produces images having poor resolution.

Another method involves delay in applying the second printing liquid until the first printing liquid is completely dry. This method is also disadvantageous, not only because of its inefficiencies, but also because it is not entirely effective.

Yet another approach to control bleed is to increase the rate of penetration of the printing liquid into the substrate, but this tends to reduce the optical density.

U.S. Pat. No. 5,488,402 discloses a method for preventing color bleed between two different color ink compositions wherein the first ink is anionic and comprises a coloring agent which includes one or more carboxyl and/or carboxylate groups, and the second ink includes a precipitating agent which is designed to ionically crosslink with the coloring agent in the first ink to form a solid precipitate in order to prevent bleed between the two ink compositions. Multivalent metal salts are disclosed as being useful as the precipitating agent.

U.S. Pat. No. 5,518,534 discloses an ink set for alleviating bleed in multicolor printed elements employing a first ink and a second ink, each containing an aqueous carrier medium and a colorant; the colorant in the first ink being a pigment dispersion and the second ink containing a salt of an organic acid or mineral acid having a solubility of at least 10 parts in 100 parts of water at 25° C., wherein the salt is present in an amount effective to alleviate bleed between the first and second inks.

Although the use of inorganic or organic salts in one or more inks of the ink set has been effective in controlling bleed, the presence of those salts causes other problems.

The known methods of controlling bleed, although effective, have various drawbacks and there is still a need for alternative methods of bleed control which do not involve use of salts, or cause loss of optical density.

### SUMMARY OF THE INVENTION

In one aspect, the present invention pertains to an inkjet ink comprising an aqueous vehicle, a colorant and a bleed control agent. The bleed control agent comprises 3-(2-methoxyphenoxy)-1-2-propanediol (abbreviated MPPD). In a preferred embodiment, the colorant comprises a self-dispersing pigment.

In another aspect, the present invention pertains to an inkjet ink set comprising at least four differently colored inks, wherein at least one of said differently colored inks comprises an aqueous vehicle and a bleed control agent comprising MPPD. In a preferred embodiment, the at least four differently colored inks comprise a magenta, yellow, cyan and black ink, wherein the black ink comprises an aqueous vehicle, carbon black pigment and MPPD.

The bleed control agent 3-(2-methoxyphenoxy)-1-2-propanediol is also known by the common name “guaifenesin” and has the Chemical Abstracts Number [93-14-1] and is commercially available from several sources including Aldrich (Milwaukee, Wis., USA).

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

As indicated above, inkjet inks in accordance with the present invention generally comprise an aqueous vehicle, a colorant and a bleed control agent comprising MPPD. Optionally, other ingredients (additives) may be present in the ink. The ink vehicle is the liquid carrier (or medium) for the colorant and additives. The ink colorant refers to any and all species in the ink that provide color and can be a single colored species, or a plurality of colored species collectively defining the final ink color.

### Vehicle

The term “aqueous vehicle” refers to a vehicle comprised of water and one or more organic, water-soluble vehicle components commonly referred to as co-solvents or humectants. Sometimes in the art, when a co-solvent can assist in the penetration and drying of an ink on a printed substrate, it is referred to as a penetrant.

Examples of water-soluble organic solvents and humectants include: alcohols, ketones, keto-alcohols, ethers and others, such as thiodiglycol, sulfolane, 2-pyrrolidone, imidazolidinone, 1,3-dimethyl-2-imidazolidinone, bis(2-hydroxyethyl)-5,5-dimethyl hydantion and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

Examples of co-solvents that commonly act as penetrants include higher alkyl glycol ethers and/or 1,2-alkanediols. Glycol ethers include, for example, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-alkanediol penetrants include linear, for example, 1,2-(C5 to C8)alkanediols and especially 1,2-pentanediol and 1,2-hexanediol.

The aqueous vehicle typically will contain about 65 wt % to about 95 wt % water with the balance (i.e., about 35% to about 5%) being organic, water-soluble vehicle components. The amount of aqueous vehicle in the ink is typically in the range of about 75 wt % to about 99.8 wt % based on the total weight of ink.

### Colorant

The colorant can be any suitable colorant. Typical colorants known in the art can be soluble (dye) or insoluble and dispersed (pigment) in the vehicle. In a preferred embodiment the colorant comprises pigment.

Raw pigment is insoluble and typically non-dispersible in the ink vehicle and must be treated in order to form a stable dispersion. One way to stabilize a pigment to dispersion is by treatment with a dispersant. The term “dispersant” as used herein is generally synonymous with the terms “dispersing agent” and “suspending agent” which are also found in the art.

The dispersant can be any suitable dispersant such as, for example, those disclosed in U.S. Pat. Nos. 4,597,794; 5,085,698; 5,519,085 and 6,143,807. Also, the dispersant can be, for example, those dispersants disclosed in U.S. Pat. Nos. 5,708,095 and 6,136,890; and U.S. Patent Pub. No. US2005/0090599.

To prepare a dispersion, the pigment and dispersant are premixed and then dispersed or deflocculated in a milling step. The premixture includes an aqueous carrier medium (such as water and, optionally, a water-miscible solvent) when the milling step involves a wet milling operation. The milling may be accomplished in a 2-roll mill, media mill, a horizontal mini mill, a ball mill, an attritor, or by passing an aqueous premix through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the dispersant and the pigment under pressure. The media for the media mill is chosen from commonly available media, including zirconia, YTZ® (Nikkato Corporation, Osaka, Japan), and nylon. These various dispersion processes are in a general sense well-known in the art, as exemplified by U.S. Pat. Nos. 5,022,592, 5,026,427, 5,310,778, 5,891,231, 5,679,138, 5,976,232 and U.S. Patent Pub. No. 2003/0089277. The pigment dispersion as made is typically in a concentrated form (dispersion concentrate), which is subsequently diluted with a suitable liquid containing the desired additives to make the final ink.

The pigment can also be a so-called self-dispersing pigment. The term self-dispersing pigment (“SDP”) refers to pigment particles whose surface has been chemically modified with hydrophilic dispersibility-imparting groups that allow stable dispersion in an aqueous vehicle without separate dispersant. The hydrophilic dispersibility-imparting surface groups are typically ionizable.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle.

Most commonly, the dispersibility-imparting groups are carboxylate or sulfonate groups which provide the SDP with a negative charge when dispersed in aqueous vehicle. The carboxylate or sulfonate groups are usually associated with monovalent and/or divalent cationic counter-ions.

Self-dispersing pigments are described, for example, in the following U.S. Pat. Nos. 5,571,311; 5,609,671; 5,968,243; 5,928,419; 6,323,257; 5,554,739; 5,672,198; 5,698,016; 5,718,746; 5,749,950; 5,803,959; 5,837,045; 5,846,307; 5,895,522; 5,922,118; 6,123,759; 6,221,142; 6,221,143; 6,281,267; 6,329,446; 6,332,919; 6,375,317; 6,287,374; 6,398,858; 6,402,825; 6,468,342; 6,503,311; 6,506,245 and 6,852,156.

Commercial sources of SDP include Cabot Corporation, Billerica, Mass., USA, and Orient Corporation of America, Kenilworth, N.J., USA.

Examples of pigments with coloristic properties useful in inkjet inks include: (cyan) Pigment Blue 15:3 and Pigment Blue 15:4; (magenta) Pigment Red 122 and Pigment Red 202; (yellow) Pigment Yellow 14, Pigment Yellow 74, Pigment Yellow 95, Pigment Yellow 110, Pigment Yellow 114, Pigment Yellow 128 and Pigment Yellow 155; (red) Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; (green) Pigment Green 1, Pigment Green 2, Pigment Green 7 and Pigment Green 36; (blue) Pigment Blue 60, Pigment Violet 3, Pigment Violet 19, Pigment Violet 23, Pigment Violet 32, Pigment Violet 36 and Pigment Violet 38; and (black) carbon black. However, some of these pigments may be not be suitable for preparation as SDP. Colorants are referred to herein by their “C.I.” designation established by Society Dyers and Colourists, Bradford, Yorkshire, UK and published in the The Color Index, Third Edition, 1971.

The range of useful particle size after dispersion is typically about 0.005 micron to about 15 micron. Preferably, the pigment particle size should range from about 0.005 to about 5 micron and, most preferably, from about 0.005 to about 1 micron. The average particle size as measured by dynamic light scattering is less than about 500 nm, preferably less than about 300 nm.

The levels of pigment employed in formulated inks are those levels needed to impart the desired optical density to the printed image. Typically, pigment levels are in the range of about 0.01 wt % to about 10 wt %, and more typically from about 1 wt % to about 9 wt %.

### Other Ingredients (Additives)

Other ingredients, additives, may be formulated into the inkjet ink, to the extent that such other ingredients do not interfere with the stability and jetablity of the ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont). Surfactants are typically used in amounts up to about 5% and more typically in amounts of no more than 2%.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or dispersed, and can be ionic or nonionic.

Soluble polymers may include linear homopolymers, copolymers or block polymers, they also can be structured polymers including graft or branched polymers, stars and dendrimers. The dispersed polymers may include, for example, latexes and hydrosols. The polymers may be made by any known process including but not limited to free radical, group transfer, ionic, RAFT, condensation and other types of polymerization. They may be made by a solution, emulsion, or suspension polymerization process. Preferred classes of polymer additives include anionic acrylic, styrene-acrylic or polyurethane polymer.

When soluble polymer is present, the level is commonly between about 0.01 wt % and about 3 wt %, based on the total weight of ink. Upper limits are dictated by ink viscosity or other physical limitations.

### Ink Properties

prop velocity, separation length of the droplets, drop size and stream stability are greatly affected by the surface tension and the viscosity of the ink. Ink jet inks typically have a surface tension in the range of about 20 mN·m⁻¹ to about 50 mN·m⁻¹ at 25° C. Viscosity can be as high as 30 mPa·s at 25° C., but is typically in the range of about 1 mPa·s to about 20 mPa·s at 25° C. The ink physical properties are adjusted to the ejecting conditions and printhead design. The inks should have excellent storage stability for long periods and avoid clogging the tiny orifices or the ink jet apparatus. Further, the ink should not corrode parts of the ink jet printing device it comes in contact with and should be essentially odorless and non-toxic. Preferred pH for the ink is in the range of from about 6.0 to about 8.

The various ink components can be combined in various proportions and combinations to make an ink with desired ink properties, as generally described herein above, and as generally recognized by those of ordinary skill in the art. Some experimentation may be necessary to optimize inks for a particular end use, but such optimization is generally within the ordinary skill in the art.

### Method of Printing

The method of printing prescribed herein can be accomplished with any suitable inkjet printer. The substrate can be any suitable substrate, but the instant invention is particularly useful for printing on paper, especially “plain” paper and specialty paper such as photo glossy paper.

### EXAMPLES

Inks were prepared by stirring the indicated ingredients together and filtering the resulting mixture. Water was deionized unless otherwise stated. Surfynol® 104E and 465 are surfactants from Air Products. (Allentown, Pa., USA). Glycereth 26 is a 26 mole ethoxylate of glycerol.

Abbreviations used are as follows.

PgmBE: propylene glycol mono-n-butyl ether

DEGmBE: diethylene glycol mono-n-butyl ether

MPPD: 3-(2-methoxyphenoxy)-1-2-propanediol

### Dispersion 1

Carbon black (S-160 from Degussa) was oxidized with ozone according to the process described in U.S. Pat. No. 6,852,156 to create carboxylic acid groups directly attached to the carbon black pigment surface. Potassium hydroxide was used to neutralize the treated pigment and convert the surface acid groups to the K salt form. The neutralized mixture was purified by ultra-filtration to remove free acids, salts, and contaminants. The purification process was performed to repeatedly wash pigment with de-ionized water until the conductivity of the mixture leveled off and remained relatively constant. After recovery, Dispersion 1 was a 20.5 weight percent dispersion of self-dispersing carbon black pigment.

### Optical Density

Inks were printed with a Canon PIXMA 4200 printer (in standard mode) onto Canon Office plain paper. The reported optical density (OD) values were of areas printed at 100% coverage, measured with a Greytag Macbeth Spectrolino spectrometer.

### Evaluation of Bleed

Three test patterns were made on the same sheet of paper. In the first pattern a solid horizontal black line about 400 microns wide was made on the white paper without any abutting color (referred to as black on white and abbreviated K/W). In the second pattern, a similar horizontal black line abuts, on both the upper and lower edges, a solid block of yellow color (referred to as black on yellow and abbreviated K/Y). In the third pattern, a horizontal black line similar that in the first two patterns abuts, on both the upper and lower edges, a solid block of red (yellow plus magenta) color (referred to as black on Red and abbreviated K/R).

The edge acuity of the black line in each of the three patterns was then assessed by image analysis under a microscope. A monochrome CCD camera coupled to a microscope captured a digital photomicrograph of the line. The borders of the upper and lower edges were determined by analysis of the threshold reflectivity values. The points in each border were used to calculate a straight line representing the least squares best fit of the line edge. For each edge, the root mean square deviation (RMSD) of the points in the border was calculated (in units of microns, p) relative to the least squares best fit straight line. The quantity and location of points sampled on a given sheet was sufficient to assure the analysis of line edges was statistically significant.

The RMSD is related the perception of line edge acuity. A line with a small RMSD appears sharp upon visual inspection, whereas a line with a large RMSD appears “fuzzy” or “ragged”. The method objectively quantitates the relative sharpness (or raggedness) of a line printed under different conditions.

The unevenness of the K/W line edge (RMSD K/W) is referred to a “feathering” as there is no abutting color. The unevenness of the K/Y line edge (RMSD K/Y) or K/R line edge (RMSD K/R) is a combination of feathering and “bleed” of the black into the yellow or red. Thus “bleed”, as referred to herein, is quantitated for the K/Y line as RMSD K/Y minus RMSD K/W and for the K/R line as RMSD K/R minus RMSD K/W, and is the increase in RMSD of K/Y or K/R over the RMSD of K/W.

The test patterns were printed with a Canon PIXMA 4200 printer (standard mode) on Canon Office plain paper. The black inks used to make the horizontal line are described in the examples. The yellow and magenta inks used to make the yellow and red blocks of color were the Canon CLi-8Y and Cli-8M commercial inks made for the PIXMA 4200 printer.

The RMSD may vary greatly from one brand of paper to another. Sometimes, there is substantial variation even in the same brand from one ream of paper to another. Day to day environmental variation (e.g. temperature, humidity) can also cause variability. To minimize such variability, all tests in a given series are run on the same day with paper from the same ream and the results are an average of five test patterns on five different sheets of paper.

### Example 1

The inks of this examples, summarized in the table below, demonstrate the inventive bleed control agent (ink 1 B) compared to bleed control agents PGmBE and DEGmBE (ink 1A) disclosed in U.S. Pat. No. 6,004,389, and a control sample (ink 1 C) without bleed control agent. Results show that both the inventive and comparative bleed control agents reduce bleed relative to the control, but the comparative ink suffers substantial optical density loss compared to the control whereas the inventive ink suffers at most only slight OD loss.

Prints used to measure bleed and optical density of all inks in this example were made on the same day with the same printer on Canon Office plain paper taken from the same ream.

| | Ink 1A | | Ink 1C |
|---|---|---|---|
| | (Comparative) | Ink 1B | (Control) |
| Ingredients | | | |
| Dispersion 1 | 4 | 4 | 4 |
| (as % pigment) | | | |
| Glycerol | 6 | 6 | 6 |
| 1-5 Pentanediol | 8 | 8 | 11 |
| PGmBE | 1.4 | — | — |
| DEGmBE | 1.4 | — | — |
| MPPD | — | 4 | — |
| Surfynol 104E | — | 0.033 | 0.047 |
| Water (Balance to 100) | | | |
| Properties | | | |
| Viscosity (mPa · s) | 2.53 | 2.54 | 2.58 |
| pH | 6.98 | 8.82 | 8.97 |
| Surface Tension | 40.84 | 40.91 | 41.18 |
| (mN · m⁻¹) | | | |
| Optical Density | 1.32 | 1.48 | 1.54 |
| Bleed K/Y (μ) | 41.8 | 43.8 | 82.3 |
| Bleed K/R (μ) | 47.1 | 49.5 | 110.11 |

### Example 2

The inks of this example, summarized in the table below, demonstrate the use of various levels of MPPD bleed control agent. Results show the inventive inks have reduced bleed relative to control.

Prints used to measure bleed and optical density of all inks in this example were made on the same day with the same printer on Canon Office plain paper taken from the same ream.

| | | | | Ink 2D |
|---|---|---|---|---|
| | Ink 2A | Ink 2A | Ink 2A | (control) |
| Ingredient | | | | |
| Dispersion 1 | 4 | 4 | 4 | 4 |
| (as % pigment) | | | | |
| 1,3-Propanediol | 11 | 11 | 11 | 11 |
| Glycereth 26 | 3 | 3 | 3 | 3 |
| MPPD | 2 | 4 | 8 | — |
| Surfynol 465 | 0.16 | 0.1 | 0.2 | 0.25 |
| Water (Balance to | Bal. | Bal. | Bal. | Bal. |
| 100) | | | | |
| Properties | | | | |
| Viscosity (mPa · s) | 2.37 | 2.61 | 2.89 | 2.51 |
| pH | 7.29 | 7.06 | 7.44 | 7.09 |
| Surface Tension | 41.63 | 41.63 | 41.35 | 40.68 |
| (mN · m⁻¹) | | | | |
| Optical Density | 1.52 | 1.50 | 1.32 | 1.52 |
| Bleed K/Y (μ) | 45.5 | 40.5 | 44.4 | 60.4 |
| Bleed K/R (μ) | 73.0 | 67.7 | 54.7 | 86.3 |

What is claimed is:

1. An inkjet ink comprising an aqueous vehicle, a colorant and a bleed control agent comprising 3-(2-methoxyphenoxy)-1-2-propanediol.

2. The inkjet ink of claim 1 wherein the colorant is a pigment.

3. The inkjet ink of claim 2 wherein the colorant is a self-dispersing pigment.

4. The inkjet ink of claim 3 wherein the self-dispersing pigment comprises self-dispersing carbon black.

5. An inkjet ink set comprising at least four differently colored inks, wherein at least one of said differently colored inks comprises an aqueous vehicle and a bleed control agent comprising 3-(2-methoxyphenoxy)-1-2-propanediol.

6. The inkset of claim 5 wherein said at least four differently inks comprise a magenta, yellow, cyan and black ink, and wherein said black ink comprises an aqueous vehicle, carbon black pigment and a bleed control agent comprising 3-(2-methoxyphenoxy)-1-2-propanediol and pigment.

7. The inkset of claim 6 wherein the carbon black pigment in said black ink is a self-dispersing carbon black.
